(19) United States
(12) Patent Application Publication
(10) Pub. No.: US 2006/0095323 A1
(43) Pub. Date: May 4, 2006

(54) Song identification and purchase methodology

(76) Inventor: Masahiko Muranami, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/981,182

(22) Filed: Nov. 3, 2004

(51) Int. Cl. G06Q 30/00

(52) U.S. Cl. 705/14

(57) ABSTRACT

In an embodiment, a method for identifying media content, includes: providing an audio input data; digitizing the audio input data from an analog audio waveform to a digitized audio waveform; comparing the digitized audio waveform with waveform patterns stored in an electronic library; retrieving a matching media content based upon the digitized audio waveform; and providing an identification information of the matching media content.

### TECHNICAL FIELD

Embodiments of the present invention relate generally to technology for searching media content, and more particularly to a song identification and purchase methodology.

### BACKGROUND

Individuals who hear an unfamiliar song on the radio (or other media sources) are often curious about the song title or the name of the artist associated with the song. These individuals may also have a desire to purchase the song or an album (e.g., a compact disc or CD) that contains the song. In current solutions, a listener can identify a song heard on the radio by calling the radio station (or disk jockey) in order to obtain various song information such as the artist name, the song title, or/and the album title.

When a consumer is purchasing music content via an online network (e.g., the Internet), the consumer is typically required to identify the music content to be purchased by providing the artist and song title. The consumer is not able to purchase music content by only providing the content of the song such as lyrics of a portion of the song or a melody of the song. Therefore, the current solutions require the consumer to positively identify a song to be purchased based on the song title and/or artist, and are not able to permit the consumer to instantly purchase a song if the consumer has other limited information about the song content.

Therefore, the current technology is limited in its capabilities and suffers from at least the above constraints and deficiencies.

### SUMMARY OF EMBODIMENTS OF THE INVENTION

These and other features of an embodiment of the present invention will be readily apparent to persons of ordinary skill in the art upon reading the entirety of this disclosure, which includes the accompanying drawings and claims.

In an embodiment of the invention, a method for identifying media content, includes:

providing a text input;

comparing the text input with text of a media content stored in an electronic library;

retrieving a matching media content based upon the text input; and

providing an identification information of the matching media content.

In another embodiment of the invention, an apparatus for identifying media content, includes: a device configured to receive a text input; an electronic library; a media finder configured to compare the text input with text of a media content stored in the electronic library, to retrieve a matching media content based upon the text input, and to provide an identification information of the matching media content.

In another embodiment of the invention, a method for identifying media content, includes:

providing an audio input data;

digitizing the audio input data from an analog audio waveform to a digitized audio waveform;

comparing the digitized audio waveform with waveform patterns stored in an electronic library;

retrieving a matching media content based upon the digitized audio waveform; and

providing an identification information of the matching media content.

In another embodiment of the invention, an apparatus for identifying media content, includes: a device configured to receive a audio input data; an electronic library; a media finder configured to digitize the audio input data from an analog audio waveform to a digitized audio waveform, to compare the digitized audio waveform with waveform patterns stored in the electronic library, to retrieve a matching media content based upon the digitized audio waveform, and to provide an identification information of the matching media content.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an apparatus (system), in accordance with an embodiment of the invention.

FIG. 2 is a block diagram of an apparatus (system) for identifying media content based upon text content, in accordance with an embodiment of the invention.

FIG. 3 is a flowchart of a method of identifying media content based upon text content, in accordance with an embodiment of the invention.

FIG. 4 is a block diagram of an apparatus (system) for identifying songs based on a query by humming of the songs or by providing other music content, in accordance with an embodiment of the invention.

FIG. 5 is a flowchart of a method of identifying songs based on a query by humming of the songs or by providing other music content, in accordance with an embodiment of the invention.

FIG. 6 is a block diagram of an apparatus (system) for identifying media content, where the apparatus is portable, in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

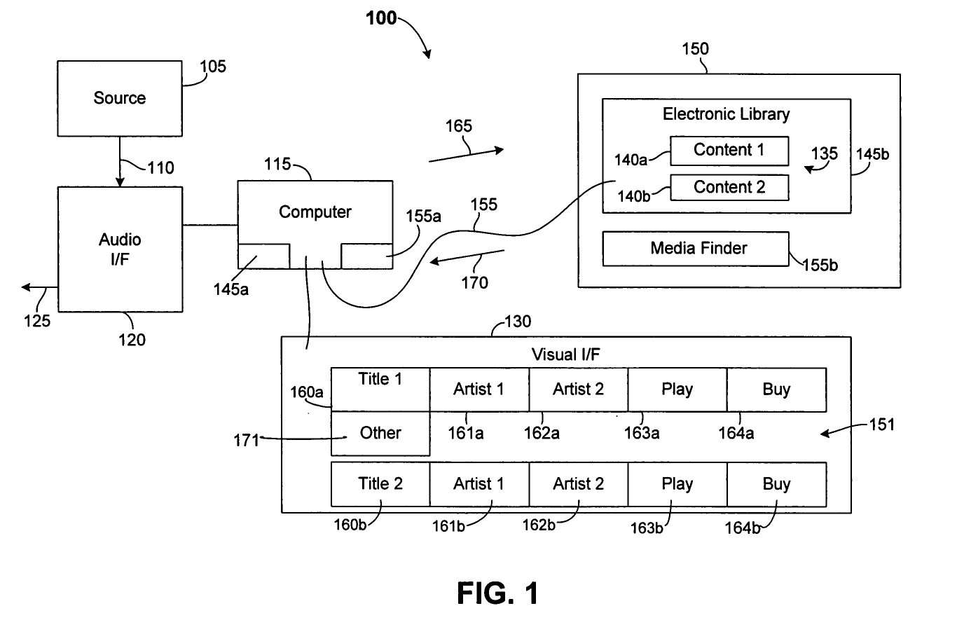

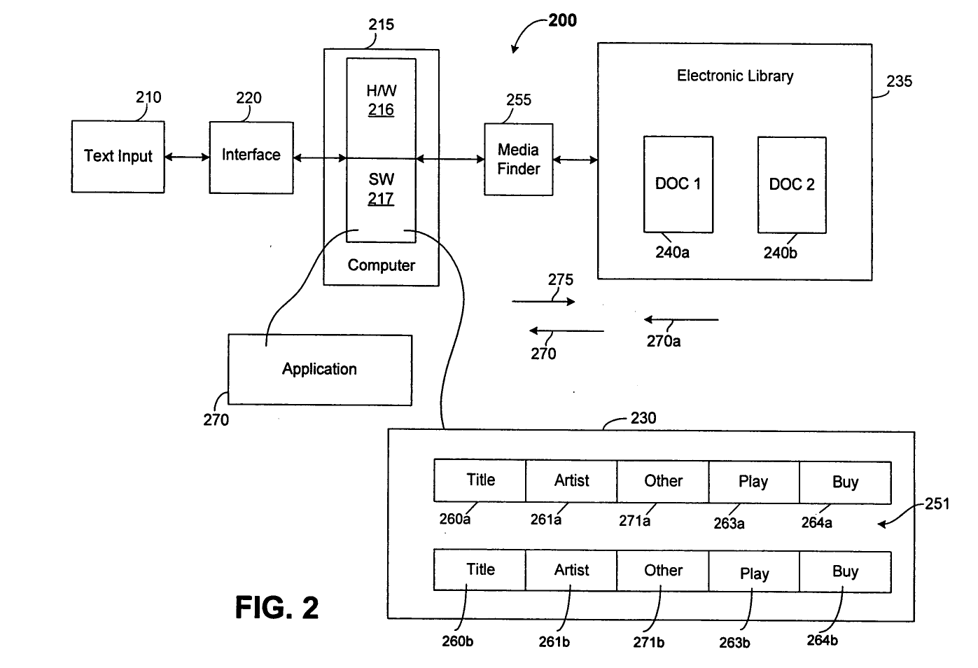

FIG. 1 is a block diagram of an apparatus (system) 100, in accordance with an embodiment of the invention. An audio source 105 generates an audio signal(s) 110 to be processed by a computer 115. The audio source 105 can be, for example: a radio, stereo, compact disk player, MP3 (MPEG-1 Audio Layer-3) player, or other types of electronic sound sources that generate audio outputs; a human who sings or hums a song, or speaks a monologue or lyric or other types of recitals; or other suitable audio sources that are known to those skilled in the art. The audio signal 110 can be, for example, a song, melody, or recital or spoken text from the audio source 105. In another embodiment as shown in FIG. 2 and as discussed below, the audio signal 110 may instead comprise text input 210, or spoken word that is converted into a text input.

The computer 115 can by any suitable computing device such as, for example, a personal computer (PC), a laptop, a notebook computer, a palmtop, a server, or other types of computing devices.

An interface device 120 can process the audio input 110. The interface device 120 is coupled to or is integrated with the computer 115. As an example, the interface device 120 can be a microphone, a line input into the computer 115, a speaker that can receive audio input, or can be other suitable devices that can receive and/or process an audio input 110. Alternatively, the interface device 120 includes an audio player (e.g., MP3 player) and a Universal Serial Bus (USB) for connecting the audio player to the computer 115. Alternatively, the interface device 120 can comprise a device that generates or processes audio signals.

The interface device 120 may also, for example, generate audio output signals 125. For example, the interface device 120 may include speaker elements that can receive audio signals 110 and output audio signals 125.

A visual interface device 130 can display visual output. The visual interface device 130 is coupled to or is integrated with the computer 115. As an example, the visual interface device 130 can be a computer display that uses a cathode-ray tube. Alternatively, the visual interface device 130 can be a liquid crystal display (LCD) device. Other suitable display devices can be used as a visual interface device 130.

In one embodiment of the invention, an electronic library 135 can store media contents 140 (e.g., media contents 140a and 140b). The media contents 140 can be, for example, music or audio files, or electronic text files, or other publication in electronic form. Alternatively or additionally, the media contents 140 can also include natural sounds (e.g., bird calls, dog barks, ocean wave sounds, rainfall, blowing wind, and/or other natural sounds). In one embodiment of the invention, the electronic library 135 is stored in a memory device 145a that is in the computer 115 or that is associated (e.g., attached) to the computer 115. In another embodiment of the invention, the electronic library 135 is stored in a memory device 145b that is in or associated with a remote computer 150. The local computer 115 can communicate with the remote computer 150 by use of a communication network 155 which may be, for example, a wide area network such as the Internet or a local area network. The memory devices 145a or 145b may be, for example, a random access memory (RAM), a memory device in a hard drive, or other suitable types of memory devices.

An example operation of the system 100 is now described. Specific example operations of specific embodiments of the invention are also discussed below. In this example operation, assume that the input signal 110 is an audio signal such as a melody to a portion of a song that is hummed by an individual. A media finder 155a will then compare the content of the input signal 110 with content stored in media contents 140 in an electronic library 135 that is in the memory 145a in the computer 115. In another embodiment, a media finder 155b will compare the content of the input signal 110 with content stored in media contents 140 in an electronic library 135 that is in the memory 145b in the remote computer 150. In the description herein, the media finder will also be generally referred to as media finder 155. Information 151 relating to the possible matching media content in the electronic library 135, as found by the media finder 155, are displayed in the visual interface 130. For example, if the media finder 155 finds the media content 140a as containing content that matches the content in the input signal 110, then the media finder 155 will display a song title 160a and artist name 161a that are associated with the media content 140a. The media finder 155 can also display a name of another artist 162a, if any, who is also associated with the content 140a. The user can select the selection 163a to hear an audio sample output of the media content 140a. Typically, the audio sample output is generated as an audio signal 125 from the interface 120 or from another audio interface. The user can also purchase the media content 140a by selecting the selection 164a. The user can send an electronic payment transaction 165 to the remote computer 150 which can then accept and process the electronic payment information 165 of the purchaser via the network 155. The remote computer 150 can then download the purchased media content 140a via network 155 as a file 170 to the computer 115. The user can then store the file 170 in the computer 115 and execute or play the file 170 on demand.

It is noted that the media finder 155 can also display other information which is shown as other information 171 in the visual interface 130. This other information 171 may indicate, for example, the origin of the song, composer name, song artist who made the song famous, song ownership information, other relevant information related to the song, or a combination of these listed information. If the media content is a published work, then the other information 171 can indicate other publication information.

If the media finder 155 finds another media content that matches the content in the input signal 110, then the information 151 may contain identification for this additional matching media content. For example, assuming that the media finder 155 finds the media content 140b as also matching the content in the input signal 110, then the media finder 155 will display a song title 160b and artist name 161b that are associated with the media content 140b. The media finder 155 can also display a name of another artist 162b, if any, who is also associated with the content 140b. The user can select the selection 163b to hear an audio sample output of the media content 140b. The user can also purchase the media content 140b by selecting the selection 164b. The user can send a payment information transaction 165 to the remote computer 150 that can accept and process the electronic payment information 165 of the purchaser via the network 155. The remote computer 150 can then download the purchased media content 140b via network 155 as a file 170 to the computer 115. Of course, other information related to the media content 140b can also be displayed in the information 151.

The computer 115 executes under the control of an operating system, such as the WINDOWS operating system from MICROSOFT CORPORATION or other types of operating systems such as, for example, OS/2, OS/390, MACINTOSH, UNIX, LINUX, or other types of operating system software. The operating system and other software or firmware in the computer 115 are executed by a processor (not shown in FIG. 1) in the computer 115.

It should be appreciated that, in alternative embodiments, the system 100 may include components and products other than those discussed above. Moreover, the system 100 can be implemented on different operating systems and hardware. Standard hardware, software, and firmware components are also not shown in FIG. 1, for purposes of clarity. Further, in alternative embodiments, any number of computers having alternative user interfaces may be used. Those skilled in the art will recognize that other alternative hardware and software environments may be used without departing from the scope of embodiments of the invention. As such, the exemplary environment in FIG. 1 is not intended to limit embodiments of the invention.

FIG. 2 is a block diagram of an apparatus (system) 200 for identifying media content based upon text content, in accordance with an embodiment of the invention. As similarly discussed above, a computer 215 can include hardware components 216 and software components 217 for permitting the computer 215 to perform particular functions including standard computing functions and unique functions as described below.

In accordance with an embodiment of the invention, a user can provide input text 210 to an interface 220. The input text 210 may be, for example, contents of a particular song, speech, script, periodical, book, magazine, or other publication, or contents of another suitable document, or natural sounds. The interface 220 may be, for example, a standard computer keyboard or touch-screen that can receive text input from the user. The interface 220 is coupled to or is integrated with the computer 215.

In other embodiments, the interface 220 has speech-to-text conversion capability, so that the user's spoken words are converted into corresponding text by the interface 220, and the media finder 255 can then process the corresponding text to perform text-to-text comparison with the text of media contents 240 stored in the electronic library 235.

In other embodiments, the interface 220 has handwriting-to-text recognition and conversion capability. For example, the user can handwrite text into the interface 220, and the interface 220 will convert the handwritten text into block text that the media finder 255 can process. The media finder 255 can process the block text to perform text-to-text comparison with text of media content 240 stored in the electronic library 235.

The media finder 255 can be associated with the local computer 215, or with a remote computer 150 (FIG. 1) that can communicate with the local computer 215 via a network 155. Similarly, the electronic library 235 can be associated with the local computer 215 or with the remote computer 155 that can communicate with the local computer 215.

The media finder 255 can search the electronic library 235 for a matching text in the stored media content (e.g., documents), by performing text-to-text comparison that is similarly performed by known search engines. The media finder 255 can be programmed by, for example, use of known programming techniques and may be based upon any suitable programming language such as, for example, C, C++ or JAVA, or derivatives thereof.

The media finder 255 can match the input text 210 with text content in the stored documents in the electronic library 235. For example, the media finder 255 performs text-to-text matching of the sequence of words or order of words in the input text 210, with the sequence or order of words in the documents in the electronic library 235. For example, if the user types the phrase:
“It's been a hard day's night, and I've been working like a dog. It's been a hard day's night, I should be sleeping like a log”.
   If the user types a portion of this phrase into the interface 220, then the media finder 255 will search the text of media contents 240 in the electronic library 235 to find possible matches. For example, the media finder 255 may find at least one of the following documents containing text that matches the text input 210: (1) a document 240a which may be the lyrics of the original song, “Hard Day's Night”©, by the Beatles; and/or (2) a document 240b which may be the lyrics of a remake version (by another artist) of the original song, “A Hard Day's Night”. The media finder 255 may find other documents (not shown in FIG. 2) that potentially matches the text input 210.

In other examples, if the text input 210 contains text portions of a publication or speech or natural sounds, or other media content, then the media finder 255 can find the matching publication(s) or speech(s) that are stored in the electronic library 235. Therefore, the media content 240 found by the media finder 255 are not necessarily limited to songs or music, but may include other types of media content that are stored in the electronic library 235.

The media finder 255 can then display identification information 251 associated with the matching documents 240a and 240b. For example, a visual interface 230 can display at least one of the following information associated with document 240a: song title 260a (e.g., “A Hard Day's Night); artist name 261a (e.g., Beatles); and/or other information 271a. The other information 271a may include, for example, the album name (“A Hard Day's Night (1964 Film)”), label name (CAPITOL), release date (Oct. 25, 1990), and/or other information. The user can listen to a playback of this song by selecting the selector 263a and/or can buy this song version by selecting the selector 264a. The playback of the song can involve playing back the entire song or a portion of the song, so that the user can verify if he or she wants to purchase the song. The audio output of the song playback can be generated, for example, from the interface 220 if the interface 220 has speakers or from another suitable sound output interface associated with the local computer 215.

As another example, the visual interface 230 can display at least one of the following information associated with document 240b: song title 260b (e.g., “A Hard Day's Night); artist name 261b (e.g., Goldie Hawn); and/or other information 271b (e.g., album name, “In My Life” (1998)). The user can listen to a playback of this song by selecting the selector 263b and/or can buy this song version by selecting the selector 264b.

Of course, the identification information 251 can be presented or formatted in other formats that are known to those skilled in the art. Therefore, the format of the identification information 251 in FIG. 2 (and in other figures herein) is not intended to limit the scope of embodiments of the invention.

The media finder 255 permits the user of computer 215 to hear a portion of a song. For example, if the user selects the selector 263a, then the hardware and software in a remote computer 150 (containing the electronic library 235) can download to the computer 215 a file 270a which may be a music file that contains a portion of the music content of the song associated with the matching document 240a.

The application 270 (in the computer 215) permits electronic-commerce based transactions to be performed between the local computer 215 and a remote computer 150 (FIG. 1) that contains the electronic library 235. The application 270 can be any standard software that permits the user of local computer 215 to engage in e-commerce transactions. For example, if the user selects the selection 264a, then the user will be able to purchase the song associated with the title 260a. The user can input electronic payment information into the interface 220. For example, the payment information is a credit card number of the user. The payment information is then transmitted as a packet 275 via the network 155 (FIG. 1) to a remote computer 150 (FIG. 1) that manages the electronic library 235. The remote computer 150 can then transmit a music file 270 to the local computer 215, in exchange for the packet 275 with the electronic payment information. The user can then play the music associated with the title 260a by playing the music file 270 on demand.

Similarly, the user can select the selection 264b in order to purchase the song associated with the title 260a by providing electronic payment information in exchange for a music file to be downloaded from the remote computer 150 to the local computer 215.

It is noted that the network 155 (FIG. 1), for transmitting the electronic payment information from the local computer 215 to the remote computer 150, may be a standard secure communication network that protects the confidential information of the user.

It is also noted that the downloaded file 270 may be other types of media content that is not limited to music files. For example, the file 270 may be an electronic copy of a publication (e.g., book or magazine or newspaper) that is downloaded from the remote computer 150 to the local computer 215, in exchange for the user's electronic payment information 275.

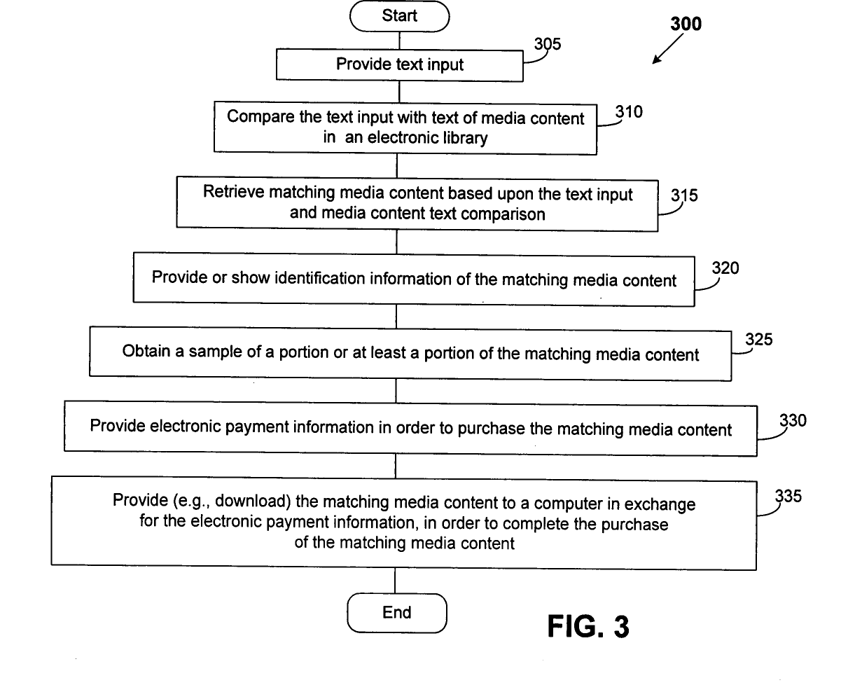

FIG. 3 is a flowchart of a method 300 of identifying media content based upon text content, in accordance with an embodiment of the invention. In step 305, the user provides a text input. In step 310, a media finder compares the text input with text of media content stored in an electronic library. In step 315, the media finder retrieves (or identifies) a matching media content based upon the text input. In step 320, identification information of the matching media content is shown or provided. In step 325, the user can obtain a sample of a portion or at least a portion of the matching media content, in order to permit verification of the matching media content. For example, the user can listen to a portion of a song, if the matching media content is music content. In step 330, the user can provide electronic payment information in order to purchase the matching media content. In step 335, a file of the matching media content is provided (e.g., downloaded) to a computer of the user in exchange for the electronic payment information, in order to complete the user's purchase of the matching media content.

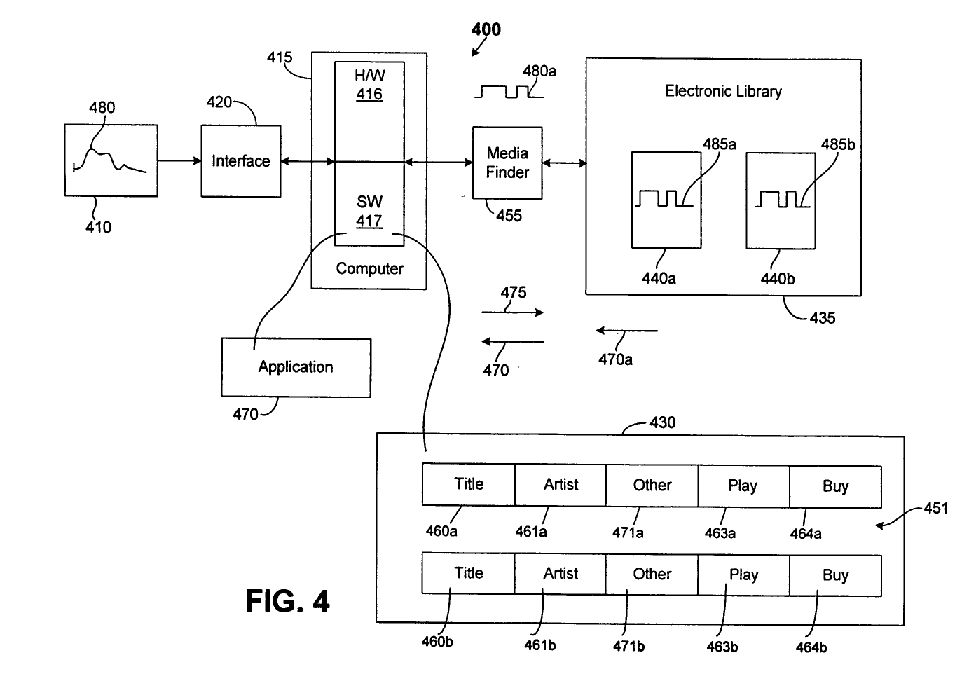

FIG. 4 is a block diagram of an apparatus (system) 400 for identifying songs based on a query by humming of the songs or by providing other music content, in accordance with an embodiment of the invention.

As similarly discussed above, a computer 415 can include hardware components 416 and software components 417 for permitting the computer 415 to perform particular functions including standard computing functions and unique functions as described below.

In accordance with an embodiment of the invention, a user can provide music content 410 to an interface 420. The music content 410 may be, for example, a melody of particular song. The user can hum the melody, particularly if the user does not know the lyrics of the song. As known to those skilled in the art, a melody is the main tune in a piece of music, often forming part of a larger piece of music.

The interface 420 can process audio input, such as the music content input 410. The interface device 420 is coupled to or is integrated with the computer 415. As an example, the interface 420 can be a microphone, a line input into the computer 415, a speaker that can receive audio input, or can be other suitable devices that can receive and process audio signal input. Alternatively, the interface 420 includes an audio player (e.g., MP3 player) and a Universal Serial Bus (USB) for connecting the audio player to the computer 415.

The interface 420 may also, for example, generate audio output signals. For example, the interface 420 may include speaker elements that can receive audio signals and output audio signals.

The media finder 455 can be associated with the local computer 415, or with a remote computer 150 (FIG. 1) that can communicate with the local computer 415 via a network 155. Similarly, the electronic library 435 can be associated with the local computer 415 or with the remote computer 150 that can communicate with the local computer 415.

The media finder 455 can search the electronic library 435 for an audio file(s) 440 associated with music contents, by performing a pattern identification of input audio data 410. As an example, the input audio data 410 may include a bit of radio broadcast, a hummed tune from an individual, music from a source (e.g., CD), or other types of audio data. The audio data 410 is received by the interface 420 as an analog audio wave 480. This analog audio wave will contain sound information such as, for example, sound pitch, speed, duration, frequency, amplitude, and other sound information. Therefore, when a user hums a portion of a melody of a song, the melody portion will have a particular waveform 480 that includes sound information of the melody.

The interface 420 will then digitize the analog audio wave 480 into a digitized audio waveform 480a. The media finder 455 will compare the digitized audio waveform 480a with stored waveform patterns 485 (e.g., patterns 485a and 485b) of audio files 440 in the electronic library 435. For example, the stored audio files 440 may be stored music or songs. The stored audio files 440 may be, for example waveform audio (.wav) files or other non-MIDI (non-Musical Instrument Digital Interface) file types.

The media finder 455 can then identify audio files 440 with stored patterns 485 that match or potentially match the digitized audio wave 480a. For example, if the digitized audio wave 480a matches at least a portion of a wave pattern 485a, then the media finder 455 will identify the audio file 440a as a matching file. Standard wave matching techniques may be used when comparing the digitized audio wave 480 with the wave patterns 485. The media finder 455 matches the sequence of values (representing music notes and other audio information) in the digitized waveform 480a with the sequence of values in a portion of the wave patterns 485.

The media finder 455 will identify matching audio files 440, based upon an exact match of the digitized audio wave 480a with at least a portion of a stored pattern 485 or based upon a relatively close match of the digitized audio wave 480a with at least a portion of a stored pattern 485. It is noted that a user may hum a melody of a song at a faster or slower speed, or at higher or lower pitch, or at other audio variations. As a result, the digitized audio waveform 480a may not necessarily exactly match a stored pattern 485 in the electronic library 435. Therefore, the media finder 455 is configured to identify potentially matching patterns 485 by identifying wave patterns 485 that exactly and closely matches the digitized waveform 480a.

A visual interface 430 can display the possible matches found in the electronic library 435. The displayed information 451 can include, for example, any of the following: (1) song title or artist, (2) multiple version of the matching song, and/or (3) multiple possible song matches to the melody of audio input 410. For example, if the user hums the melody to the song, “A Hard Day's Night”, then the media finder 455 will compare the corresponding digitized waveform 480a (of the melody) with patterns 485 in order to find possible songs that matches the melody. For example, the media finder 455 may find at least one of the following files containing patterns 485 that matches the melody: (1) a file 440a which may be the original song “Hard Day's Night” by the Beatles; and/or (2) a file 440b which may be the lyrics of a remake version (by another artist) of the original song “A Hard Day's Night”. The media finder 455 may find other files (not shown in FIG. 4) that potentially matches the melody in the digitized waveform 480a.

In other examples, if the digitized waveform 480 represents a speech or monologue that is spoken by the user or is a natural sound, then the media finder 455 can find the matching audio files of publication(s) or speech(s) or natural sounds that are stored in the electronic library 435. Therefore, the media content 440 found by the media finder 4555 are not necessarily limited to songs or music, but may include other types of media content that are stored in the electronic library 435.

The media finder 455 (via the visual interface 430) can then display identification information 451 associated with the matching audio files 440a and 440b. For example, a visual interface 430 can display at least one of the following information associated with audio file 440a: song title 460a (e.g., “A Hard Day's Night); artist name 461a (e.g., Beatles); and/or other information 471a. The user can listen to a playback of this song by selecting the selector 463a and/or can buy this song version by selecting the selector 464a. The playback of the song may be output via interface 420 or via another suitable audio interface.

As another example, the media finder 455 can display at least one of the following information associated with audio file 2440b: song title 460b (e.g., “A Hard Day's Night); artist name 461b (e.g., Goldie Hawn); and/or other information 471b. The user can listen to a playback of this song by selecting the selector 463b and/or can buy this song version by selecting the selector 464b.

The identification information 451 can be presented or formatted in other formats that are known to those skilled in the art. Therefore, the format of the identification information 451 in FIG. 4 is not intended to limit the scope of embodiments of the invention.

The media finder 455 permits the user of computer 415 to hear a portion of a song. For example, if the user selects the selector 463a, then the hardware and software in a remote computer 150 (containing the electronic library 435) can download to the computer 415 a file 470a which may be a music file that contains a portion of the music content of the song associated with matching audio file 440a.

The media finder 455 can be programmed, for example, by use of known programming techniques and may be based upon any suitable programming language such as, for example, C, C++ or JAVA, or derivatives thereof.

The application 470 (typically in the computer 415) permits electronic-commerce based transactions to be performed between the local computer 415 and a remote computer 150 (FIG. 1) that contains the electronic library 435. For example, if the user selects the selection 464a, then the user will be able to purchase the song associated with the title 460a. The user can input electronic payment information into the interface 420 or other interface (e.g., a keyboard). The payment information is then transmitted as a packet 475 via the network 155 (FIG. 1) to a remote computer 150 (FIG. 1) that manages the electronic library 435. The remote computer 150 can then transmit a music file 470 to the local computer 415, in exchange for the packet 475 with the electronic payment information. The user can then play the music associated with the title 460a by playing the music file 470 on demand.

It is noted that the downloaded file 470 may be other types of media content that is not limited to music files. For example, the file 470 may be an electronic copy of a publication (e.g., book or magazine or newspaper) that is downloaded from the remote computer 150 to the local computer 415, in exchange for the user's electronic payment information 475.

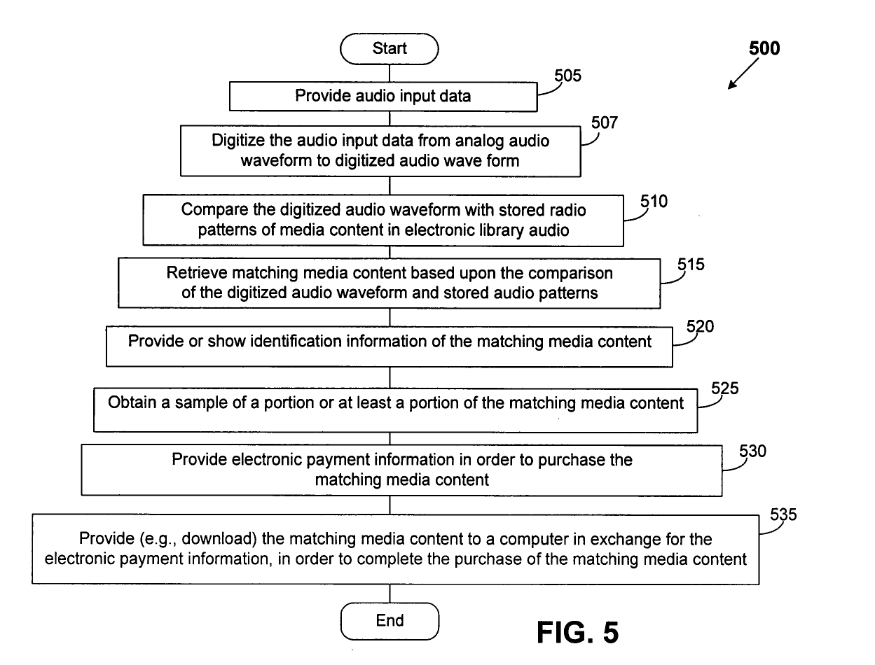

FIG. 5 is a flowchart of a method 500 of finding songs based on a query by humming of the songs or by providing other music content, in accordance with an embodiment of the invention. In step 505, the user provides audio input data, which may be, for example, a melody of a song or a speech or monologue related to a publication or a natural sound. In step 507, the audio input data is digitized from an analog audio waveform to a digitized audio waveform. In step 510, a media finder compares the digitized audio waveform with stored audio patterns in media content (e.g., audio files) in an electronic library. In step 515, the media finder retrieves (or identifies) a matching media content based upon a comparison of the digitized audio waveform and the stored audio patterns. In step 520, identification information of the matching media content is shown or provided. In step 525, the user can obtain a sample of a portion or at least a portion of the matching media content. For example, the user can listen to a portion of a song, if the matching media content is music content. In step 530, the user can provide electronic payment information in order to purchase the matching media content. In step 535, the matching media content is provided (e.g., downloaded) to a computer of the user in exchange for the electronic payment information, in order to complete the user's purchase of the matching media content.

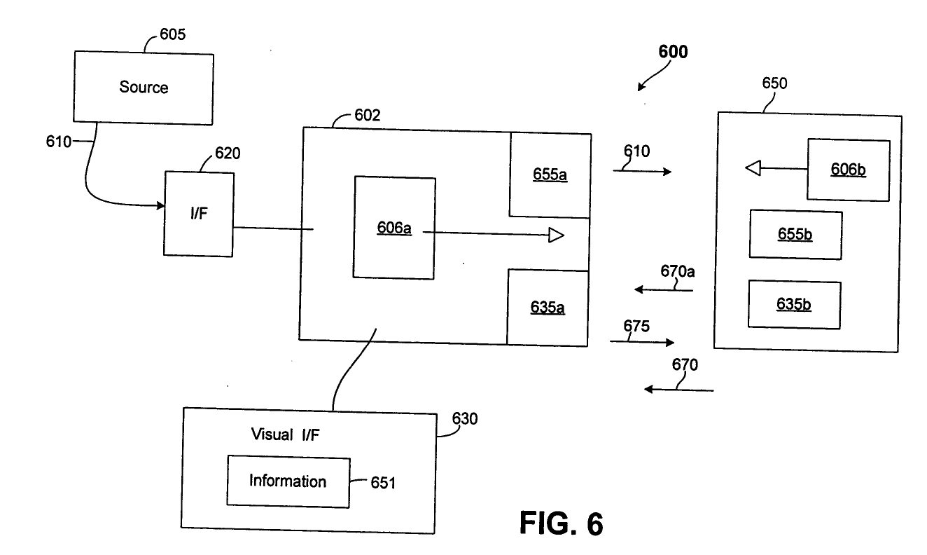

FIG. 6 is a block diagram of an apparatus (system) 600 for finding media content, where the apparatus 600 includes a device 602 that is portable, in accordance with an embodiment of the invention. The apparatus 600 permits the user to bring the device 602 to a sound source 605, instead of requiring the user to bring the sound source 605 to the device 602. For example, the user can install the device 602 in an automobile or bring the device 602 to any travel area such as a campsite or in a baseball stadium or other locations.

A source 605 generates a data signal 610 to be processed by the device 602. The source 605 can be, for example, an audio source. Examples of various audio sources were described above. Alternatively, the source 605 can be an individual or an entity or device that generates a text output. Therefore, the data signal 610 can be a text content. The interface 620 will receive and process the data signal 610. Alternatively, if the data signal is a speech signal, the interface 620 can also convert the speech signal into text, as similarly discussed above.

In one embodiment of the invention, an electronic library 635a in a memory associated with the portable device 602 can store media contents. In another embodiment of the invention, an electronic library 635b is stored in a memory associated with a remote computer 650. The portable device 602 and remote computer 650 can communicate with each other by use of transceivers 606a and 606b.

In one embodiment of the invention, a media finder 655a in the portable device 602 will compare the input data 610 with content in stored files in the electronic library 635a. The media finder 655a will then generate information 651 via visual interface 630. The information 651 provides information associated with any electronic library 635a files that match the input data 610, as similarly discussed above.

In other embodiments, the information 651 is stored in the portable device 602, and the user can then later upload the information 651 to a computer (e.g., computer 115 in FIG. 1), so that the computer 115 can display the information 651 in an associated visual interface 130. Therefore, the visual interface 630 in the portable device 602 is not an essential element.

In another embodiment of the invention, an electronic library 635b is associated with the remote computer 650. The transceiver 606a of portable device 602 will transmit the input data 610 to the transceiver 606b of the remote computer 650, and a media finder 655b in the remote computer 650 will compare the input data 610 with content in stored files in the electronic library 635b. The media finder 655a will find media contents that match the input data 610. The media finder 655b will then obtain information 651 which is then displayed in the visual interface 630 of the portable device 602, where the information 630 is associated with the matching media content(s). The transceiver 606b can transmit the information 651 from the remote computer 650 to the transceiver 606a of the portable device 602, prior to the showing of the information 651 on the visual interface 630.

The user can also hear an audio sample output of a matching media content. For example, if the matching media content is in the local electronic library 635a in the portable device 602, then the user can hear the audio sample via an audio interface (e.g., interface 620). If the matching media content is in the remote computer 650, then the transceiver 606b can transmit an audio sample 670a of the matching content to the transceiver 606a.

The user can also purchase a matching media content in the remote electronic library 635b. The user can send electronic payment information 675 from the transceiver 606a to the transceiver 606b. In exchange for the electronic payment information 675, the media finder 655b permits the transceiver 606b to send a file of the purchased media content 670 to the transceiver 606a. The user can then hear and store the media content 670 in the portable device 602.

In alternative embodiments, the user can instead use the computer 115 to purchase the matching media content from the remote computer 650.

It should be appreciated that, in alternative embodiments, the system 600 may include components and products other than those discussed above. Moreover, the system 600 can be implemented on different operating systems and hardware. Standard hardware, software, and firmware components are also not shown in FIG. 6, for purposes of clarity. Further, in alternative embodiments, any number of computers having alternative user interfaces may be used. Those skilled in the art will recognize that other alternative hardware and software environments may be used without departing from the scope of embodiments of the invention. As such, the exemplary environment in FIG. 6 is not intended to limit embodiments of the invention.

In summary, an embodiment of the invention permits at least some of the following advantages. The user can hear a song on an audio source (e.g., radio or stereo or CD player), record at least a portion of the song, input the recorded song portion (or direct the sound source to a device input interface0, and obtain the artist and title or other information of the song. Alternatively, the user can hum a tune into an audio interface device (e.g., a microphone) and obtain the artist and title or other information of the song. The user can play back possible matches to confirm that the returned song(s) is consistent with the song that the user had in mind. The user can also purchase the returned song(s).

Therefore, an embodiment of the invention permits a user to positively identify a song based on how the song sounds. The user can also instantly purchase an identified song. It is also noted that embodiments of the invention are not limited to identification of songs or music contents. The methods described herein can be used to find matches for: (1) natural sounds (e.g., bird calls, dog barks, ocean wave sounds, wind sounds, or the like); (2) spoken words (e.g., the user can quote (speak or input) a passage and the method can identify the title of the relevant document or the original speaker or author); or (3) readings (e.g., the user can read or input some lines, and the method can identify the title of the relevant document, author, publisher, or purchase information).

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing disclosure. Further, at least some of the components of an embodiment of the invention may be implemented by using a programmed general purpose digital computer, by using application specific integrated circuits, programmable logic devices, or field programmable gate arrays, or by using a network of interconnected components and circuits.

It will also be appreciated that one or more of the elements depicted in the drawings/figures can also be implemented in a more separated or integrated manner, or even removed or rendered as inoperable in certain cases, as is useful in accordance with a particular application.

It is also within the scope of an embodiment of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for identifying media content, the method comprising:
providing a text input;
comparing the text input with text of a media content stored in an electronic library;
retrieving a matching media content based upon the text input; and
providing an identification information of the matching media content.

2. The method of claim 1, further comprising:
obtaining a sample of the matching media content, in order to permit verification of the matching media content.

3. The method of claim 1, further comprising:
providing electronic payment information in order to purchase the matching media content.

4. The method of claim 3, further comprising:
providing a file of the matching media content in exchange for the electronic payment information, in order to complete the purchase of the matching media content.

5. The method of claim 1, wherein the electronic library is stored in a local computer.

6. The method of claim 1, wherein the electronic library is stored in a remote computer.

7. The method of claim 1, wherein the matching media content comprises a music file.

8. The method of claim 1, wherein the matching media content comprises an electronic file of a publication.

9. The method of claim 1, wherein the matching media content comprises an electronic file of a natural sound.

10. The method of claim 1, wherein the text input is provided to a portable device.

11. An apparatus for identifying media content, the apparatus comprising:
a device configured to receive a text input;
an electronic library;
a media finder configured to compare the text input with text of a media content stored in the electronic library, to retrieve a matching media content based upon the text input, and to provide an identification information of the matching media content.

12. The apparatus of claim 11, wherein the media finder is configured to provide a sample of the matching media content, in order to permit verification of the matching media content.

13. The apparatus of claim 11, further comprising:
a remote computer configured to receive electronic payment information in order to permit purchase the matching media content.

14. The apparatus of claim 13, wherein the remote computer is configured to provide a file of the matching media content in exchange for the electronic payment information, in order to complete the purchase of the matching media content.

15. The apparatus of claim 13, wherein the electronic library is stored in the device.

16. The apparatus of claim 11, wherein the electronic library is stored in a remote computer.

17. The apparatus of claim 11, wherein the matching media content comprises a music file.

18. The apparatus of claim 11, wherein the matching media content comprises an electronic file of a publication.

19. The apparatus of claim 11, wherein the matching media content comprises an electronic file of a natural sound.

20. The apparatus of claim 11, wherein the device is a portable device.

21. A method for identifying media content, the method comprising:
providing an audio input data;
digitizing the audio input data from an analog audio waveform to a digitized audio waveform;
comparing the digitized audio waveform with waveform patterns stored in an electronic library;
retrieving a matching media content based upon the digitized audio waveform; and
providing an identification information of the matching media content.

22. The method of claim 21, further comprising:
obtaining a sample of the matching media content, in order to permit verification of the matching media content.

23. The method of claim 21, further comprising:
providing electronic payment information in order to purchase the matching media content.

24. The method of claim 23, further comprising:
providing a file of the matching media content in exchange for the electronic payment information, in order to complete the purchase of the matching media content.

25. The method of claim 21, wherein the electronic library is stored in a local computer.

26. The method of claim 21, wherein the electronic library is stored in a remote computer.

27. The method of claim 21, wherein the matching media content comprises a music file.

28. The method of claim 21, wherein the matching media content comprises an electronic file of a publication.

29. The method of claim 21, wherein the matching media content comprises an electronic file of a natural sound.

30. The method of claim 21, wherein the audio input data is provided to a portable device.

31. An apparatus for identifying media content, the apparatus comprising:
a device configured to receive a audio input data;
an electronic library;
a media finder configured to digitize the audio input data from an analog audio waveform to a digitized audio waveform, to compare the digitized audio waveform with waveform patterns stored in the electronic library, to retrieve a matching media content based upon the digitized audio waveform, and to provide an identification information of the matching media content.

32. The apparatus of claim 31, wherein the media finder is configured to provide a sample of the matching media content, in order to permit verification of the matching media content.

33. The apparatus of claim 31, further comprising:
a remote computer configured to receive electronic payment information in order to permit purchase the matching media content.

34. The apparatus of claim 33, wherein the remote computer is configured to provide a file of the matching media content in exchange for the electronic payment information, in order to complete the purchase of the matching media content.

35. The apparatus of claim 33, wherein the electronic library is stored in the device.

36. The apparatus of claim 31, wherein the electronic library is stored in a remote computer.

37. The apparatus of claim 31, wherein the matching media content comprises a music file.

38. The apparatus of claim 31, wherein the matching media content comprises an electronic file of a publication.

39. The apparatus of claim 31, wherein the matching media content comprises an electronic file of a natural sound.

40. The apparatus of claim 31, wherein the device is a portable device.

41. An article of manufacture, comprising:
a machine-readable medium having stored thereon instructions to:
digitize the audio input data from an analog audio waveform to a digitized audio waveform;
compare the digitized audio waveform with waveform patterns stored in an electronic library;
retrieve a matching media content based upon the digitized audio waveform; and
provide an identification information of the matching media content.

42. An apparatus for identifying media content, the apparatus comprising:
means for providing an audio input data;
means for digitizing the audio input data from an analog audio waveform to a digitized audio waveform;
means for comparing the digitized audio waveform with waveform patterns stored in an electronic library;
means for retrieving a matching media content based upon the digitized audio waveform; and
means for providing an identification information of the matching media content.
